(19) United States
(12) Patent Application Publication
(10) Pub. No.: US 2016/0081098 A1
(43) Pub. Date: Mar. 17, 2016

(54) CHANNEL COMPETITION METHOD AND DEVICE

(71) Applicant: Huawei Technologies Co., Ltd., Shenzhen (CN)

(72) Inventors: Tianyu WU, Shenzhen (CN); Yunbo LI, Shenzhen (CN); Yi LUO, Shenzhen (CN)

(21) Appl. No.: 14/946,428

(22) Filed: Nov. 19, 2015

Related U.S. Application Data
(63) Continuation of application No. PCT/CN2013/087313, filed on Nov. 18, 2013.

(30) Foreign Application Priority Data
May 21, 2013 (CN) 201310190470.4

(51) Int. Cl. H04W 72/08; H04W 72/04; H04W 74/08

(52) U.S. Cl. CPC H04W 72/08; H04W 74/0808; H04W 72/0453

(57) ABSTRACT

A channel competition method, includes: a first device detecting whether a target channel contains an idle sub-channel which is in an idle state or not, and if so, sending a request frame to a second device over a target sub-channel, wherein the target sub-channel is at least one sub-channel which is contained in the idle sub-channel; and when the first device receives a response frame sent by the second device, the first device determining that the competition for the target sub-channel is successful, wherein the response frame is a response frame issued by the second device to the request frame. Correspondingly, further provided is a corresponding device. The embodiments of the present application can improve the spectrum efficiency of a network system.

### CROSS-REFERENCE TO RELATED APPLICATIONS

This application is a continuation of International Patent Application No. PCT/CN2013/087313, filed on Nov. 18, 2013, which claims priority to Chinese Patent Application No. 201310190470.4, filed on May 21, 2013, both of which are hereby incorporated by reference in their entireties.

### TECHNICAL FIELD

The present application relates to the field of communication, particularly to a channel competition method and a device thereof.

### BACKGROUND

In wireless local area networks (WLAN) system, data transmission of a station (STA) competes for a channel based on a mechanism of carrier sense multiple access with collision avoidance (CSMA/CA). In this mechanism, if a STA succeeds in the competition, the STA may use a whole frequency band of a basic service set (BSS) to which the STA belongs to transmit data, and if there is interference in a sub-band of the bands, the transmission at the whole frequency band fails.

At present, the above problem is mainly solved through a back-off mechanism. In the back-off mechanism, an access point (AP) or STA maintains a back-off timer, and the back-off timer is set with a random back-off time. After the AP or STA detects an idle channel, the back-off timer is started when the channel is idle for a period of (Distributed Inter-Frame Spacing) DIFS, and the competition is launched when timing of the back-off timer ends. If in the back-off period, the AP or STA senses a data frame transmitted on the channel from other devices, the back-off timer is frozen and is restarted after a next detection that the channel is idle for the period of DIFS. The competition is launched when the timing of the back-off timer ends. In this technology, the AP or STA may launch the competition only when the timing of the back-off timer ends and no other devices compete currently, i.e., only one device can succeed in the channel competition at the same time.

In the above technology, since only one device can succeed in the channel competition at the same time, spectrum efficiency of the network system is very low.

### SUMMARY

A channel competition method and a device thereof are provided, which may improve spectrum utilization rate of the network system.

In one aspect, a channel competition method according to the embodiments of the disclosure includes:

detecting, by a first device, whether a target channel includes sub-channel(s) in an idle state, and if it is detected that the target channel includes the idle sub-channel(s) in the idle state, the first device transmitting a request frame to a second device on a target sub-channel, where the target sub-channel is at least one sub-channel included in the idle sub-channel(s); and

confirming, by the first device, a success in a competition for the target sub-channel once the first device receives a response frame sent from the second device, wherein the response frame is a response frame from the second device in response to the request frame.

In a second aspect, a channel competition method is provided according to the embodiments of the disclosure, including:

receiving, by a second device, on a target sub-channel, a request frame sent by a first device; where the target sub-channel is at least one sub-channel of idle sub-channel(s) in idle state included in a target channel.

generating, by the second device, a response frame in response to the request frame, and transmitting the response frame to the first device, so that the first device confirms a success in competition for the target sub-channel.

In a third aspect, a channel competition device is provided according to the embodiments of the disclosure, including a detecting module, a transmitting module and a conforming module, where:

the detecting module is configured to detect whether a target channel includes sub-channel(s) in an idle state;

the transmitting module is configured to transmit a request frame to a second device on a target sub-channel in a case that the detecting module detects that the target channel includes the idle sub-channel(s) in the idle state; where the target sub-channel is at least one sub-channel included in the idle sub-channel(s); and

the conforming module is configured to confirm a success in a competition for the target sub-channel once the channel competition device receives a response frame sent by the second device; where the response frame is a response frame from the second device in response to the request frame.

In a fourth aspect, a channel competition device is provided according to the embodiments of the disclosure, including a receiving module and a transmitting module, where

the receiving module is configured to receive, on a target sub-channel, a request frame sent by a first device; where the target sub-channel is at least one sub-channel of idle sub-channel(s) in an idle state included in a target channel;

the transmitting module is configured to generate a response frame in response to the request frame, and transmit the response frame to the first device, so that the first device confirms a success in a competition for the target sub-channel.

In the above technical solutions, the first device detects whether the target channel includes idle sub-channel(s) in idle state, and if it is detected that the target channel includes the idle sub-channel(s) in the idle state, the first device transmits a request frame to a second device on a target sub-channel, where the target sub-channel is at least one sub-channel included in the idle sub-channel(s); and once the first device receives the response frame sent from the second device, the first device confirms the success in competition for the target sub-channel, where the response frame is response frame from the second device in response to the request frame. The first device only competes for a part of sub-channels of the target channel, and other devices may compete for other parts of the sub-channels of the target channel, thus spectrum utilization rate of the network system may be improved.

### BRIEF DESCRIPTION OF THE DRAWINGS

FIG. 1 is a flow chart of a channel competition method according to an embodiment of the application;

FIG. 2 is a diagram of another channel competition method according to an embodiment of the application;

FIG. 3 is a flow chart of another channel competition method according to an embodiment of the application;

FIG. 4 is a flow chart of another channel competition method according to an embodiment of the application;

FIG. 5 is a flow chart of another channel competition method according to an embodiment of the application;

FIG. 6 is a diagram of another channel competition method according to an embodiment of the application;

FIG. 7 is a structural diagram of a channel competition device according to an embodiment of the application;

FIG. 8 is a structural diagram of another channel competition device according to an embodiment of the application;

FIG. 9 is a structural diagram of another channel competition device according to an embodiment of the application;

FIG. 10 is a structural diagram of another channel competition device according to an embodiment of the application; and

FIG. 11 is a structural diagram of another channel competition device according to an embodiment of the application.

### DETAILED DESCRIPTION OF THE EMBODIMENTS

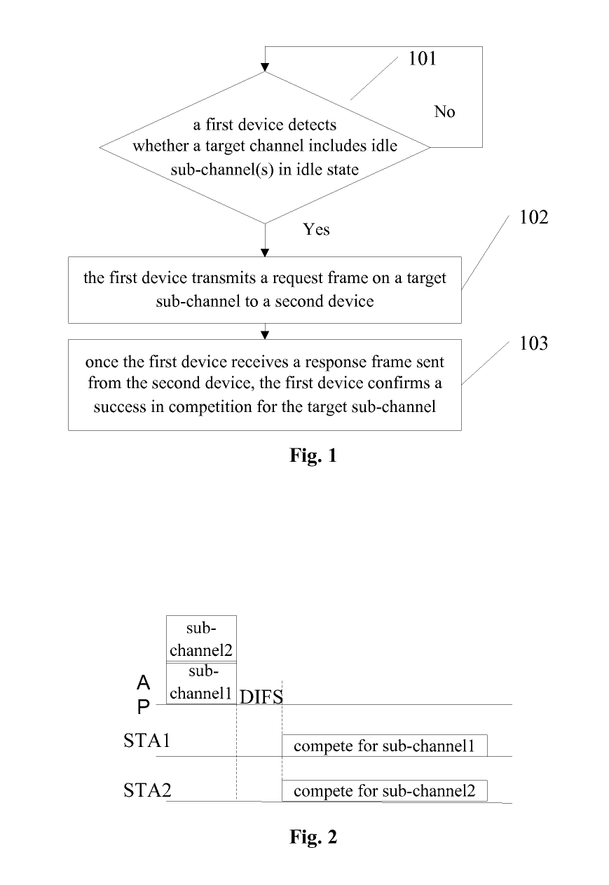

FIG. 1 is a flow chart of a channel competition method according to an embodiment of the application. As shown in FIG. 1, the method includes:

Step 101, a first device detects whether a target channel includes idle sub-channel(s) in an idle state; if it is detected that the target channel includes the idle sub-channel(s) in the idle state, the process proceeds to step 102, and if it is detected that the target channel includes no idle sub-channel in the idle state, the process proceeds to step 101;

Step 102, the first device transmits a request frame on a target sub-channel to a second device; where the target sub-channel is at least one sub-channel included in the idle sub-channel(s);

Step 103, once the first device receives a response frame sent from the second device, the first device confirms a success in competition for the target sub-channel; where the response frame is a response frame from the second device in response to the request frame.

Optionally, the first device may be a STA, or an AP. The second device may also be an AP, or a STA. In a case that the first device is a STA, the second device may also be a STA, or an AP, and in a case that the first device is an AP, the second device may be a STA, or an AP.

Optionally, the target channel may be any channel in a network system.

Optionally, when the first device competes for the target sub-channel, other devices may also compete for sub-channels in the target channel other than the target sub-channel. For example, as shown in FIG. 2, idle sub-channels of the target channel between the AP side and the STA include sub-channel 1 and sub-channel 2, thus STAT and STA2 may compete for sub-channel 1 and sub-channel 2 respectively after a fixed period (e.g., DIFS) since sub-channel 1 and sub-channel 2 are detected.

Optionally, the forgoing request frame may be a data frame, and the forgoing response frame may be a confirmation frame, such as acknowledgement (ACK). The forgoing request frame may also be a short channel request frame (such as RTS frame, where RTS is a frame name defined in a protocol, without Chinese meaning), and the forgoing response frame may be a channel request response frame (such as CTS frame or a predefined response frame, where CTS is a frame name defined in the protocol, without Chinese meaning) In the embodiments of the application, the request frame and response frame include but are not limited to the forgoing described request frames and response frames.

In the above technical solution, the first device detects whether the target channel includes the idle sub-channel(s) in the idle state; if it is detected that the target channel includes the idle sub-channel(s) in the idle state, the first device transmits, on the target sub-channel, the request frame to the second device, where the target sub-channel is at least one sub-channel included in the idle sub-channel(s); and once the first device receives the response frame sent from the second device, the first device confirms the success in competition for the target sub-channel, where the response frame is a response frame from the second device in response to the request frame. The first device only competes for a part of sub-channels of the target channel, and other devices may compete for other parts of the sub-channels of the target channel, thus spectrum utilization rate of the network system may be improved.

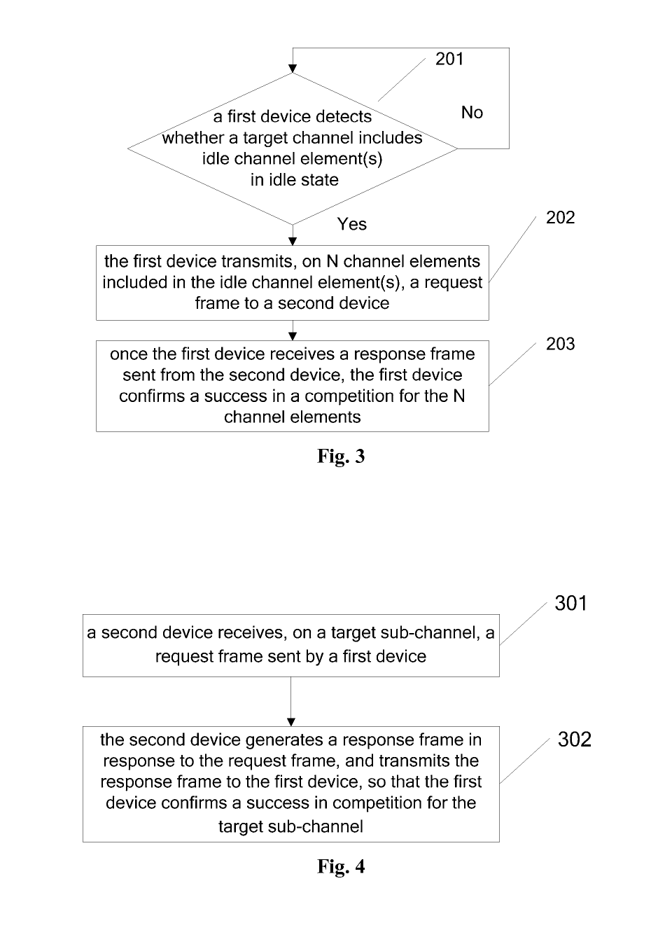

FIG. 3 is a flow chart of another channel competition method according to an embodiment of the application. As shown in FIG. 3, the method includes:

Step 201, a first device detects whether a target channel includes idle channel element(s) in an idle state; if it is detected that the target channel includes the idle channel element(s) in the idle state, the process proceeds to step 202, and if it is detected that the target channel includes no idle channel element in the idle state, the process proceeds to step 201.

The target channel includes a plurality of channel elements, and the channel elements include:

at least one sub-carrier or at least one sub-channel.

Optionally, one channel element may include one sub-carrier, or one channel element includes a plurality of continuous sub-carriers, or one channel element includes a plurality of discontinuous sub-carriers, or one channel element includes one or more sub-channels.

Optionally, it may be predefined that the target channel includes a plurality of channel elements, and each channel element may be a minimum channel unit for the first device to launch a competition, i.e., the forgoing first device may launch the competition on any channel element included in the target channel.

Step 202, the first device transmits, on N channel elements included in the idle channel element(s), a request frame to a second device; where N is less than or equal to M, and M is a preset maximum quantity of channel elements participating the competition.

For example, in step 201, it is detected that the target channel includes 5 idle channel sub-elements, and in a case that M is 4, the request frame may be sent on at most 4 idle channel sub-elements in step 202; in another example, in step 201, it is detected that the target channel includes 5 idle channel sub-elements, and in a case that M is 7, the request frame may be sent on at most 5 idle channel sub-elements in step 202.

Optionally, the forgoing request frame may include at least one of the following:

identification information of the second device, identification information of the first device, length of a target data packet, quantity information of the requested time-frequency resource, channel feedback information, and quality of service (QoS) information.

Optionally, in a case that the first device is an AP, the forgoing request frame may further include information for scheduling the second device.

Step 203, once the first device receives a response frame sent from the second device, the first device confirms a success in a competition for the N channel elements; where the response frame is a response frame from the second device in response to the request frame.

Optionally, after the first device confirms the success in the competition for the target sub-channel, the first device may transmit the target data packet to the second device through the forgoing target sub-channel.

As an optional implementation, step 203 includes:

once the first device receives, on a first target channel element, the response frame sent from the second device, the first device confirms a success in the competition for the first target channel element, where the first target channel element is one or more channel elements included in the N channel elements.

The forgoing first target channel element is one or more channel elements included in the forgoing N channel elements, i.e., as long as any one or more of the forgoing N channel elements receive the response frame sent from the second device, the success in competition for the forgoing first target channel may be confirmed. In other words, the second device transmits the response frame to the first device only on the successfully competed channel element.

As an optional implementation, step 203 includes:

once the first device receives, on a second target channel element, the response frame sent from the second device, the first device confirms a success in the competition for the N channel elements, where the second target channel element is any one channel element or any multiple channel elements included in the target channel.

Optionally, in the implementation, the second device may transmit the response frame to the first device on all channel elements of the target channel. Once receiving the response frame on any one channel element or any multiple channel elements among all channel elements of the target channel, the first device confirms a success in a competition for the N channel elements.

As an optional implementation, before step 202, the method may further include:

analyzing, by the first device, a quantity of channel elements required for transmitting a target data packet, and then setting a maximum quantity of the channel elements participating the competition based on the quantity;

where the target data packet is the data packet needing to compete for transmission on the at least one sub-channel, i.e., the purpose of the channel competition method in the disclosure is to transmit the target data packet.

For example, in a case that the target data packet is a video or audio data packet, maximum quantity of the channel elements participating the competition may be set at a relatively large value in the above steps, thus the competition may be launched on more channel elements, to compete for more channel elements with higher probability. For example, in a case that the target data packet is a background or text data packet, the maximum quantity of the channel elements participating the competition may be set at a relatively small value in the above steps, thus the competition may be launched on fewer channel elements, to compete for fewer channel elements. In other words, in the implementation, the first device may set the maximum quantity of the channel elements participating the competition in real time based on the target data packet.

As an optional implementation, before step 202, the method may further include:

setting by the first device, based on a pre-obtained mapping relationship between data packets and the maximum quantities of the channel elements participating the competition, a quantity corresponding to the target data packet in the mapping relationship as the maximum quantity of the channel elements participating the competition.

Optionally, in the implementation, the mapping relationship between the data packets sent by the AP or other devices and the maximum quantities of the channel elements participating the competition may be pre-obtained, and the mapping relationship indicates the maximum quantities of the channel elements participating the competition which should be set for the data packets.

As an optional implementation, in a case that the first device is AP, before step 202, the method may further include:

setting, by the first device, a pre-designated number corresponding to the first device as the maximum quantity of the channel elements participating the competition. Since the number of STAs is greater than that of APs in a BSS, it is difficult for the AP to succeed in the competition in a case that the maximum quantity of the channel elements participating the competition set for the AP is equal to the maximum quantity of the channel elements participating the competition set for the STA, i.e., a probability of success competition of a downlink data packet is much smaller than that of a uplink data packet. To achieve a balance between the competition probabilities of uplink and downlink data packets, the maximum quantity of the channel elements participating the competition set for the AP may be set at a larger value, i.e., the pre-designated number corresponding to the first device is larger.

As an optional implementation, in a case that the first device is AP, before step 202, the method may further include:

setting, by the first device, a quantity of all channel elements included in the target channel as the maximum quantity of the channel elements participating the competition. Thus the AP may launch the competition on the whole frequency band (all channel elements included in the target channel), and in this case, the AP succeeds in the competition as long as no conflict occurs on an arbitrary channel element.

In the above technical solution, a variety of channel competition methods are conceived based on the embodiments, which may improve spectrum utilization rate of the network system.

FIG. 4 is a flow chart of another channel competition method according to an embodiment of the application. As shown in FIG. 4, the method includes:

Step 301, a second device receives, on a target sub-channel, a request frame sent by a first device; where the target sub-channel is at least one of idle sub-channel(s) in an idle state included in a target channel.

Step 302, the second device generates a response frame in response to the request frame, and transmits the response frame to the first device, so that the first device confirms a success in competition for the target sub-channel.

Optionally, the first device may be a STA, or an AP. The second device may also be an AP, or a STA. In a case that the first device is a STA, the second device may also be a STA, or an AP, and in a case that the first device is an AP, the second device may be a STA, or an AP.

Optionally, the target channel may be any channel in a network system.

Optionally, when the first device competes for the target sub-channel, other devices may also compete for sub-channels in the target channel other than the target sub-channel. For example, as shown in FIG. 2, idle sub-channels of the target channel between the AP side and the STA include sub-channel 1 and sub-channel 2, thus STAT and STA2 may compete for sub-channel 1 and sub-channel 2 respectively after a fixed period (e.g., DIFS) since sub-channel 1 and sub-channel 2 are detected.

Optionally, the forgoing request frame may be a data frame, and the forgoing response frame may be a confirmation frame, such as acknowledgement (ACK). The forgoing request frame may also be a short channel request frame (such as RTS frame, where RTS is a frame name defined in a protocol, without Chinese meaning), and the forgoing response frame may be a channel request response frame (such as CTS frame or a predefined response frame, where CTS is a frame name defined in the protocol, without Chinese meaning) In the embodiments of the application, the request frame and response frame include but are not limited to the forgoing described request frames and response frames.

In the above technical solution, the second device receives, on the target sub-channel, the request frame sent by the first device; where the target sub-channel is at least one of idle sub-channel(s) in an idle state included in the target channel; and the second device generates the response frame in response to the request frame, and transmits the response frame to the first device, so that the first device confirms the success in competition for the target sub-channel. The first device only competes for a part of sub-channels of the target channel, and other devices may compete for other parts of the sub-channels of the target channel, thus spectrum utilization rate of the network system may be improved.

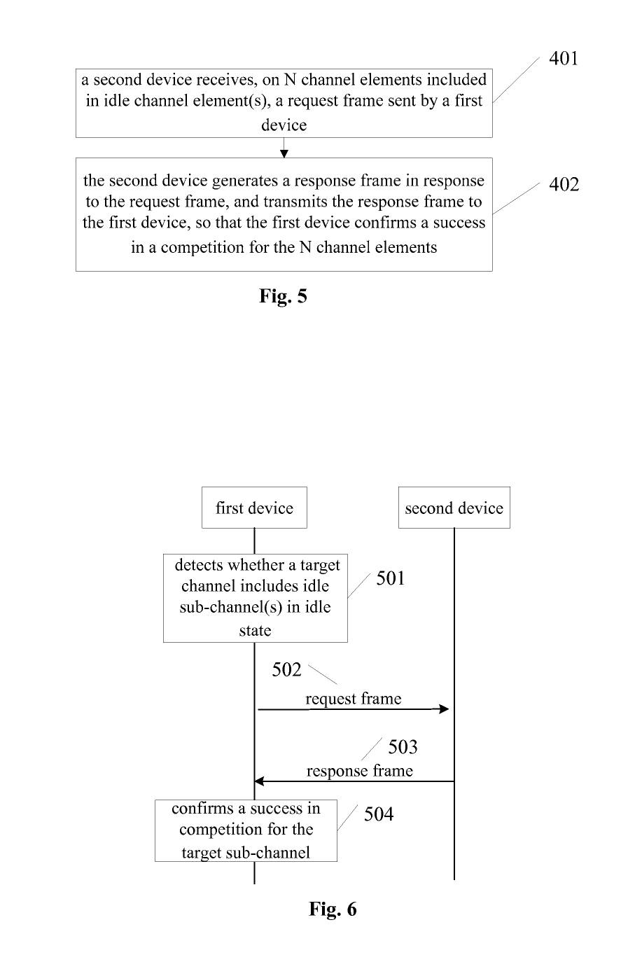

FIG. 5 is a flow chart of another channel competition method according to an embodiment of the application. As shown in FIG. 5, the method includes:

Step 401, a second device receives, on N channel elements included in idle channel element(s), a request frame sent by a first device; where the idle channel element is channel element in the idle state included in a target channel, N is less than or equal to M, and M is a maximum quantity, preset by the first device, of channel elements participating the competition.

The target channel includes a plurality of channel elements, and the channel elements includes:

at least one sub-carrier or at least one sub-channel.

Optionally, the forgoing request frame may include at least one of the following:

identification information of the second device, identification information of the first device, length of a target data packet, quantity information of the requested time-frequency resource, channel feedback information, and quality of service (QoS) information.

Optionally, in a case that the first device is an AP, the forgoing request frame may further include information for scheduling the second device.

Step 402, the second device generates a response frame in response to the request frame, and transmits the response frame to the first device, so that the first device confirms a success in a competition for the N channel elements.

As an optional implementation, transmitting the response frame to the first device in step 402 may include:

transmitting, by the second device, the response frame to the first device on a first target channel element, so that the first device confirms a success in the competition for the first target channel element, where the first target channel element is one or more channel elements included in the N channel elements.

As an optional implementation, step 402 may include:

transmitting, by the second device, the response frame to the first device on a second target channel element, so that the first device confirms a success in a competition for the N channel elements, where the second target channel element is any one channel element or any multiple channel elements included in the target channel.

Optionally, in a case that the second device is an AP, the second device may transmit, on the second target channel element, the response frame to a plurality of first devices simultaneously, the response frames sent to respective first devices may be the same or different, and the response frames may further include resource dispatch information and time-frequency resource information corresponding to respective first devices.

In the above technical solution, a variety of channel competition methods are conceived based on the embodiments, which may improve spectrum utilization rate of the network system.

FIG. 6 is a diagram of another channel competition method according to an embodiment of the application. As shown in FIG. 6, the method includes:

Step 501, a first device detects whether a target channel includes sub-channel(s) in an idle state, if it is detected that the target channel includes the idle sub-channel(s) in the idle state, the process proceeds to step 502, and if it is detected that the target channel includes no idle sub-channel in the idle state, the process proceeds to step 501;

Step 502, the first device transmits, on a target sub-channel, a request frame to a second device; where the target sub-channel is at least one sub-channel included in the idle sub-channel(s);

Step 503, the second device transmits a response frame to the first device, where the response frame is a response frame from the second device in response to the request frame;

Step 504, the first device confirms a success in competition for the target sub-channel.

In the above technical solution, the first device detects whether the target channel includes the idle sub-channel(s) in the idle state; if it is detected that the target channel includes the idle sub-channel(s) in the idle state, the first device transmits, on the target sub-channel, the request frame to the second device; where the target sub-channel is at least one sub-channel included in the idle sub-channel(s); the first device confirms the success in competition for the target sub-channel once receiving the response frame sent by the second device; where the response frame is a response frame from the second device in response to the request frame. The first device only competes for a part of sub-channels of the target channel, and other devices may compete for other parts of the sub-channels of the target channel, thus spectrum utilization rate of the network system may be improved.

The following are device embodiments of the application, which are configured to execute the first to fifth method embodiments of the application. For convenient illustration, only parts related with embodiments of the application are shown. For specific technical details that are not disclosed, the first, second, third, fourth and fifth embodiments may be referred to.

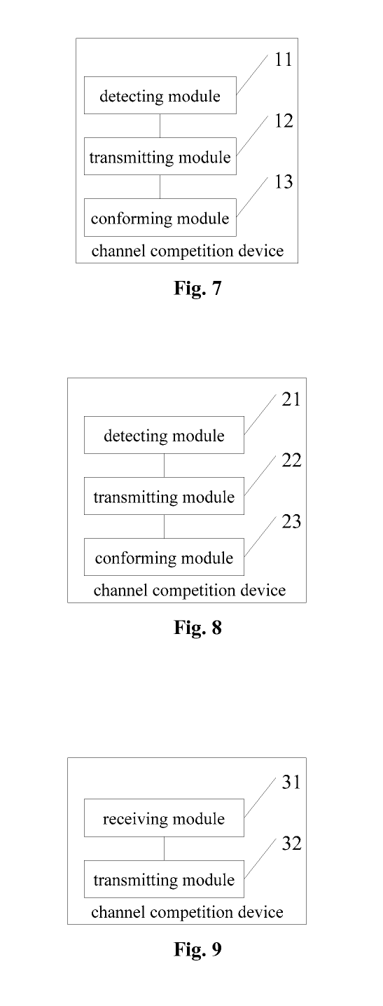

FIG. 7 is a structural diagram of a channel competition device according to an embodiment of the application. As shown in FIG. 7, the device includes a detecting module 11, a transmitting module 12 and a conforming module 13, where:

the detecting module 11 is configured to detect whether a target channel includes sub-channel(s) in an idle state;

the transmitting module 12 is configured to transmit, a request frame to a second device on a target sub-channel in a case that the detecting module 11 detects that the target channel includes the idle sub-channel(s) in the idle state; where the target sub-channel is at least one sub-channel included in the idle sub-channel(s); and

the conforming module 13 is configured to confirm a success in a competition for the target sub-channel once the channel competition device receives a response frame sent by the second device; where the response frame is a response frame from the second device in response to the request frame.

Optionally, the channel competition device may be a STA, or an AP. The second device may also be an AP, or a STA.

In the above technical solution, the channel competition device detects whether the target channel includes the idle sub-channel(s) in the idle state, if it is detected that the target channel includes the idle sub-channel(s) in the idle state, the channel competition device transmits, on the target sub-channel, the request frame to the second device; where the target sub-channel is at least one sub-channel included in the idle sub-channel(s); and the channel competition device confirms the success in competition for the target sub-channel once receiving the response frame sent by the second device; where the response frame is a response frame from the second device in response to the request frame. The channel competition device only competes for a part of sub-channels of the target channel, and other devices may compete for other parts of the sub-channels of the target channel, thus spectrum utilization rate of the network system may be improved.

FIG. 8 is a structural diagram of another channel competition device according to an embodiment of the application. As shown in FIG. 8, the device includes a detecting module 21, a transmitting module 22 and a conforming module 23, where:

the detecting module 21 is configured to detect whether a target channel includes idle channel element(s) in an idle state.

The target channel includes a plurality of channel elements, and the channel elements include:

at least one sub-carrier or at least one sub-channel.

Optionally, one channel element may include one sub-carrier, or one channel element includes a plurality of continuous sub-carriers, or one channel element includes a plurality of discontinuous sub-carriers, or one channel element includes one or more sub-channels.

The transmitting module 22 is configured to, in a case that the detecting module 21 detects that the target channel includes the idle channel element(s) in the idle state, transmit a request frame to a second device on N channel elements included in idle channel element(s); where N is less than or equal to M, and M is a preset maximum quantity of channel elements participating the competition.

Optionally, the forgoing request frame may include at least one of the following:

identification information of the second device, identification information of the channel competition device, length of a target data packet, quantity information of the requested time-frequency resource, channel feedback information, and QoS information.

Optionally, in a case that the channel competition device is an AP, the forgoing request frame may further include information for scheduling the second device.

The conforming module 23 is configured to confirm a success in a competition for the N channel elements once the channel competition device receives a response frame sent by the second device; where the response frame is a response frame from the second device in response to the request frame.

As an optional implementation, the conforming module 23 is further configured to confirm a success in a competition for a first target channel element, once the channel competition device receives on the first target channel element a response frame sent by the second device, where the first target channel element is one or more channel elements included in the N channel elements.

As an optional implementation, the conforming module 23 is further configured to confirm a success in a competition for the N channel elements, once the channel competition device receives on a second target channel element a response frame sent by the second device, where the second target channel element is any one channel element or any multiple channel elements included in the target channel.

As an optional implementation, the channel competition device may further include:

a first setting unit (not shown in the drawings), configured to analyze a quantity of channel elements required for transmitting a target data packet, and then set a maximum quantity of channel elements participating the competition based on the quantity;

where the target data packet is the data packet needing to compete for transmission on the at least one sub-channel.

As an optional implementation, the channel competition device may further include:

a second setting unit (not shown in the drawings), configured to set, based on a pre-obtained mapping relationship between data packets and the maximum quantities of the channel elements participating the competition, a quantity corresponding to the target data packet in the mapping relationship as the maximum quantity of the channel elements participating the competition;

where the target data packet is the data packet needing to compete for transmission on the at least one sub-channel.

As an optional implementation, the channel competition device is an access point device, and the channel competition device may further include:

a third setting unit (not shown in the drawings), configured to set a pre-designated number corresponding to the first device as the maximum quantity of the channel elements participating the competition.

As an optional implementation, the channel competition device is an access point device, and the channel competition device may further include:

a fourth setting unit (not shown in the drawings), configured to set a quantity of all channel elements included in the target channel as the maximum quantity of the channel elements participating the competition.

In the above technical solution, a variety of channel competition methods are conceived based on the embodiments, which may improve spectrum utilization rate of the network system.

FIG. 9 is a structural diagram of another channel competition device according to an embodiment of the application. As shown in FIG. 9, the device includes a receiving module 31 and a transmitting module 32, where:

the receiving module 31 is configured to receive, on a target sub-channel, a request frame sent by a first device; where the target sub-channel is at least one sub-channel of idle sub-channel(s) in an idle state included in a target channel; and

the transmitting module 32 is configured to generate a response frame in response to the request frame, and transmit the response frame to the first device, so that the first device confirms a success in competition for the target sub-channel.

As an optional implementation, the target channel includes a plurality of channel elements, and the channel elements include:

at least one sub-carrier or at least one sub-channel.

Optionally, the receiving module 31 may further configured to receive, on N channel elements included in idle channel element(s), the request frame sent by the first device; where the idle channel element is the channel element in the idle state included in the target channel, N is less than or equal to M, and M is a maximum quantity, preset by the first device, of channel elements participating the competition.

Optionally, the transmitting module 32 may further configured to transmit, on a first target channel element, the response frame to the first device, so that the first device confirms a success in the competition for the first target channel element, where the first target channel element is one or more channel elements included in the N channel elements; or

Optionally, the transmitting module 32 may further configured to transmit, on a second target channel element, the response frame to the first device, so that the first device confirms a success in a competition for the N channel elements, where the second target channel element is any one channel element or any multiple channel elements included in the target channel.

Optionally, the first device may be a STA, or an AP. The channel competition device may also be an AP, or a STA.

Optionally, the target channel may be an arbitrary channel in a network system.

In the above technical solution, the second device receives, on the target sub-channel, the request frame sent by the first device; where the target sub-channel is at least one sub-channel of idle sub-channel(s) in the idle state included in the target channel; the second device generates the response frame in response to the request frame, and transmits the response frame to the first device, so that the first device confirms the success in competition for the target sub-channel. The first device only competes for a part of sub-channels of the target channel, and other devices may compete for other parts of the sub-channels of the target channel, thus spectrum utilization rate of the network system may be improved.

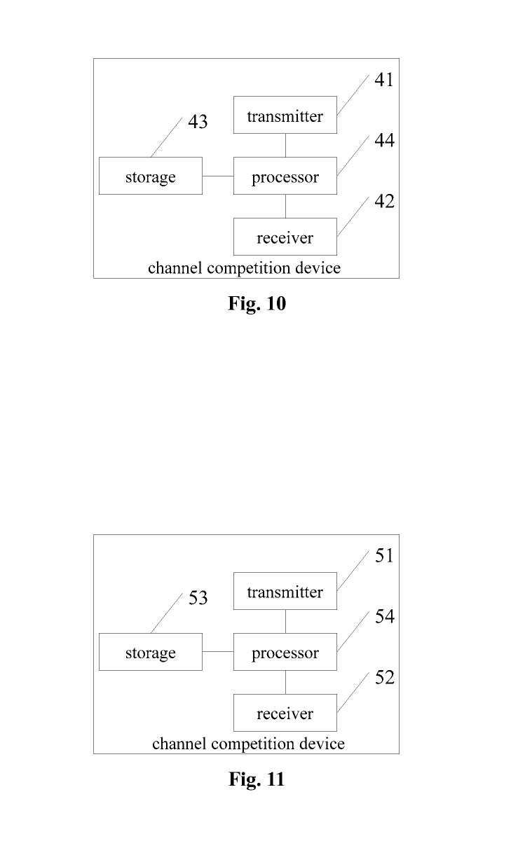

FIG. 10 is a structural diagram of another channel competition device according to an embodiment of the application. As shown in FIG. 10, the device includes a transmitter 41, a receiver 42, a storage 43, and a processor 44 connected to the transmitter 41, the receiver 42 and the storage 43. The storage 43 stores a set of program codes, and the processor 44 is configured to invoke the program codes stored in the storage 43 to execute the following operations:

detecting, through the transmitter 41 and receiver 42, whether a target channel includes sub-channel(s) in an idle state, and controlling the transmitter 41 to transmit, on a target sub-channel, a request frame to a second device if it is detected that the target channel includes the idle sub-channel(s) in the idle state; where the target sub-channel is at least one sub-channel included in the idle sub-channel(s); and

confirming a success in competition for the target sub-channel once the receiver 42 receives a response frame sent from the second device; where the response frame is a response frame from the second device in response to the request frame.

Optionally, the first device may be a STA, or an AP. The channel competition device may also be an AP, or a STA.

Optionally, the target channel may be nay channel in a network system.

In another optional embodiment, the processor 44 is further configured to execute the following operations:

detecting, through the transmitter 41 and receiver 42, whether the target channel includes idle channel element(s) in idle state, and controlling the transmitter 41 to transmit, on N channel elements included in the idle channel element(s), the request frame to the second device if it is detected that the target channel includes the idle channel element(s) in the idle state; where N is less than or equal to M, and M is a preset maximum quantity of channel elements participating the competition; and

confirming a success in a competition for the N channel elements once the receiver 42 receives the response frame sent from the second device; where the response frame is response frame from the second device in response to the request frame.

The target channel includes a plurality of channel elements, and the channel elements include:

at least one sub-carrier or at least one sub-channel.

Optionally, one channel element may include one sub-carrier, or one channel element includes a plurality of continuous sub-carriers, or one channel element includes a plurality of discontinuous sub-carriers, or one channel element includes one or more sub-channels.

Optionally, it may be predefined that the target channel includes a plurality of channel elements, and each channel element may be a minimum channel unit for the first device to launch a competition, i.e., the forgoing first device may launch the competition on any channel element included in the target channel.

Optionally, the forgoing request frame may include at least one of the following:

identification information of the second device, identification information of the channel competition device, length of a target data packet, quantity information of the requested time-frequency resource, channel feedback information, and QoS information.

Optionally, in a case that the channel competition device is an AP, the forgoing request frame may further include information for scheduling the second device.

As an optional implementation, confirming, by the processor 44, a success in a competition for the N channel elements once the receiver 42 receives the response frame sent from the second device may include:

confirming a success in a competition for a first target channel element once the receiver 42 receives, on the first target channel element, the response frame sent from the second device, where the first target channel element is one or more channel elements included in the N channel elements.

As an optional implementation, confirming, by the processor 44, a success in a competition for the N channel elements once the receiver 42 receives the response frame sent from the second device may include:

confirming, by the first device, a success in the competition for the N channel elements once the receiver 42 receives, on a second target channel element, the response frame sent from the second device, where the second target channel element is any one channel element or any multiple channel elements included in the target channel.

As an optional implementation, before controlling the transmitter 41 to transmit the request frame to the second device on N channel elements included in the idle channel element(s), the processor 44 is further configured to execute the following operations:

setting, based on a pre-obtained mapping relationship between data packets and the maximum quantities of the channel elements participating the competition, a quantity corresponding to the target data packet in the mapping relationship as the maximum quantity of the channel elements participating the competition.

The target data packet is the data packet needing to compete for transmission on the at least one sub-channel, i.e., the purpose of the channel competition method in the disclosure is to transmit the target data packet.

As an optional implementation, before controlling the transmitter 41 to transmit the request frame to the second device on N channel elements included in the idle channel element(s), the processor 44 is further configured to execute the following operations:

analyzing a quantity of channel elements required for transmitting a target data packet, and then setting a maximum quantity of channel elements participating the competition based on the quantity;

where the target data packet is the data packet needing to compete for transmission on the at least one sub-channel, i.e., the purpose of the channel competition method in the disclosure is to transmit the target data packet.

As an optional implementation, in a case that the channel competition device is an AP, the processor 44 is further configured to execute the following operations before controlling the transmitter 41 to transmit the request frame to the second device on N channel elements included in the idle channel element(s):

setting a quantity of all channel elements included in the target channel as the maximum quantity of the channel elements participating the competition.

As an optional implementation, in a case that the channel competition device is an AP, the processor 44 is further configured to execute the following operations before controlling the transmitter 41 to transmit the request frame to the second device on N channel elements included in the idle channel element(s):

setting, by the first device, a pre-designated number corresponding to the first device as the maximum quantity of the channel elements participating the competition.

In the above technical solution, the channel competition device detects whether the target channel includes the idle sub-channel(s) in the idle state, if it is detected that the target channel includes the idle sub-channel(s) in the idle state, the channel competition device transmits, on the target sub-channel, the request frame to the second device; where the target sub-channel is at least one sub-channel included in the idle sub-channel(s); and the channel competition device confirms the success in competition for the target sub-channel once receiving the response frame sent by the second device; where the response frame is a response frame from the second device in response to the request frame. The first device only competes for a part of sub-channels of the target channel, and other devices may compete for other parts of the sub-channels of the target channel, thus spectrum utilization rate of the network system may be improved.

FIG. 11 is a structural diagram of another channel competition device according to an embodiment of the application. As shown in FIG. 11, the device includes a transmitter 51, a receiver 52, a storage 53, and a processor 54 connected to the transmitter 51, the receiver 52 and the storage 53. The storage 53 stores a set of program codes, and the processor 54 is configured to invoke the program codes stored in the storage 43 to execute the following operations:

controlling the receiver 52 to receive, on a target sub-channel, a request frame sent by a first device; where the target sub-channel is at least one sub-channel of idle sub-channel(s) in an idle state included in a target channel; and

generating a response frame in response to the request frame, and controlling the transmitter 52 to transmit the response frame to the first device, so that the first device confirms a success in competition for the target sub-channel.

Optionally, the first device may be a STA, or an AP. The channel competition device may also be an AP, or a STA.

Optionally, the target channel may be an arbitrary channel in a network system.

In another optional implementation, the processor 54 is further configured to execute the following operations:

controlling the receiver 52 to receive, on N channel elements included in idle channel element(s), the request frame sent by the first device; where the idle channel element is channel element in the idle state included in the target channel, N is less than or equal to M, and M is a maximum quantity, preset by the first device, of channel elements participating the competition; and

generating a response frame in response to the request frame, and controlling the transmitter 51 to transmit the response frame to the first device, so that the first device confirms a success in a competition for the N channel elements.

The target channel includes a plurality of channel elements, and the channel elements include:

at least one sub-carrier or at least one sub-channel.

Optionally, the forgoing request frame may include at least one of the following:

identification information of the second device, identification information of the first device, length of a target data packet, quantity information of the requested time-frequency resource, channel feedback information, and quality of service (QoS) information.

Optionally, in a case that the first device is an AP, the forgoing request frame may further include information for scheduling the second device.

As an optional implementation, controlling, by the processor 54, the transmitter 51 to transmit the response frame to the first device, may include:

controlling the transmitter 51 to transmit the response frame to the first device on a first target channel element, so that the first device confirms a success in the competition for the first target channel element, where the first target channel element is one or more channel elements included in the N channel elements.

As an optional implementation, controlling, by the processor 54, the transmitter 51 to transmit the response frame to the first device, may include:

controlling the transmitter 51 to transmit the response frame to the first device on a second target channel element, so that the first device confirms a success in a competition for the N channel elements, where the second target channel element is any one channel element or any multiple channel elements included in the target channel.

In the above technical solution, the second device receives, on the target sub-channel, the request frame sent by the first device; where the target sub-channel is at least one sub-channel of idle sub-channel(s) in the idle state included in the target channel; and the second device generates the response frame in response to the request frame, and transmits the response frame to the first device, so that the first device confirms the success in competition for the target sub-channel. The first device only competes for a part of sub-channels of the target channel, and other devices may compete for other parts of the sub-channels of the target channel, thus spectrum utilization rate of the network system may be improved.

Those skilled in the art may understand that, all of or a part of the steps implementing the above methods may be accomplished through related hardware instructed by programs, and the programs may be stored in a computer readable storage medium. The programs may include the steps of the method embodiments when being executed, and the storage medium may be disc, compact disc, read-only memory (ROM), random access memory (RAM), etc.

Preferred embodiments of the disclosure are described above, and are not intended to limit the scope of the disclosure. Any equivalent modification based on the claims of the disclosure should falls in the scope of the disclosure.

1. A channel competition method, comprising:
detecting, by a first device, whether a target channel comprises one or more sub-channels in an idle state, and if the first device detects that the target channel comprises one or more sub-channels in the idle state, transmitting a request frame to a second device on a target sub-channel, wherein the target sub-channel is comprised in the one or more sub-channels; and
confirming, by the first device, a success in a competition for the target sub-channel once the first device receives a response frame sent from the second device, wherein the response frame is a response frame from the second device in response to the request frame.

2. The method according to claim 1, wherein:
the target channel comprises a plurality of channel elements, and the channel elements comprise at least one sub-carrier or at least one sub-channel;
the detecting, by the first device, whether the target channel comprises one or more sub-channels comprises: detecting, by a first device, whether the target channel comprises one or more idle channel elements in idle state; and
the transmitting the request frame to the second device on the target sub-channel by the first device comprises: transmitting, by the first device, the request frame to the second device on N channel elements comprised in the one or more idle channel elements, wherein N is less than or equal to M, and M is a preset maximum quantity of channel elements participating the competition.

3. The method according to claim 2, before transmitting, by the first device, the request frame to the second device on the N channel elements, further comprising:
analyzing, by the first device, a quantity of channel elements required for transmitting a target data packet, and setting a maximum quantity of channel elements participating the competition based on the quantity; or
setting, by the first device, based on a pre-obtained mapping relationship between data packets and the maximum quantities of the channel elements participating the competition, a quantity corresponding to the target data packet in the mapping relationship as the maximum quantity of the channel elements participating the competition;
wherein the target data packet is the data packet needing to compete for transmission on the at least one sub-channel.

4. The method according to claim 2, wherein the first device is an access point device, and before transmitting, by the first device, the request frame to the second device on the N channel elements, the method further comprises:
setting, by the first device, a pre-designated number corresponding to the first device as the maximum quantity of the channel elements participating the competition; or
setting, by the first device, a quantity of all channel elements comprised in the target channel as the maximum quantity of the channel elements participating the competition.

5. The method according to claim 3, wherein the confirming, by the first device, the success in competition for the target sub-channel once receiving the response frame sent by the second device, comprises:
once the first device receives, on a first target channel element, the response frame sent from the second device, confirming, by the first device, a success in the competition for the first target channel element, wherein the first target channel element is one or more channel elements comprised in the N channel elements; or
once the first device receives, on a second target channel element, the response frame sent from the second device, confirming, by the first device, a success in a competition for the N channel elements, where the second target channel element is any one channel element or any multiple channel elements comprised in the channel element.

6. A channel competition method, comprising:
receiving, by a second device, on a target sub-channel, a request frame sent by a first device, wherein the target sub-channel is at least one sub-channel of one or more idle sub-channels in idle state comprised in a target channel;
generating, by the second device, a response frame in response to the request frame; and
transmitting the response frame to the first device, so that the first device confirms a success in competition for the target sub-channel.

7. The method according to claim 6, wherein:
the target channel comprises a plurality of channel elements, and the channel elements comprise at least one sub-carrier or at least one sub-channel; and
the receiving, by the second device, on the target sub-channel, the request frame sent by the first device, comprises: receiving, by the second device, on N channel elements comprised in the one or more idle channel elements, the request frame sent by the first device, wherein N is less than or equal to M, and M is a maximum quantity, preset by the first device, of channel elements participating the competition.

8. The method according to claim 7, wherein the transmitting, by the second device, the response frame to the first device, comprises:
transmitting, by the second device, on a first target channel element, the response frame to the first device, so that the first device confirming a success in the competition for the first target channel element, wherein the first target channel element is one or more channel elements comprised in the N channel elements; or
transmitting, by the second device, on a second target channel element, the response frame to the first device, so that the first device confirming a success in a competition for the N channel elements, wherein the second target channel element is any one channel element or any multiple channel elements comprised in the target channel.

9. A channel competition device, comprising a detector, a transmitter, and a processor, wherein:
the detector is configured to detect whether a target channel comprises one or more idle sub-channels in an idle state;
the transmitter is configured to transmit a request frame to a second device on a target sub-channel in a case that the detector detects that the target channel comprises one or more idle sub-channels in the idle state, wherein the target sub-channel is at least one sub-channel comprised in the one or more idle sub-channels; and
the processor is configured to confirm a success in a competition for the target sub-channel once the channel competition device receives a response frame sent by the second device, wherein the response frame is a response frame from the second device in response to the request frame.

10. The device according to claim 9, wherein:
the target channel comprising a plurality of channel elements, and the channel elements comprise at least one sub-carrier or at least one sub-channel; and
the detector is further configured to detect that the target channel comprises one or more idle channel elements in the idle state; and
the transmitter is further configured to, once the detector detects that the target channel comprises one or more idle channel elements in idle state, transmit, on N channel elements comprised in the one or more idle channel elements, the request frame to the second device, wherein N is less than or equal to M, and M is a preset maximum quantity of channel elements participating the competition.

11. The device according to claim 9, further comprising:
a first setting unit, configured to analyze a quantity of channel elements required for transmitting a target data packet, and then set a maximum quantity of channel elements participating the competition based on the quantity; or
a second setting unit, configured to set, based on a pre-obtained mapping relationship between data packets and the maximum quantities of the channel elements participating the competition, a quantity corresponding to the target data packet in the mapping relationship as the maximum quantity of the channel elements participating the competition;
wherein the target data packet is the data packet needing to compete for transmission on the at least one sub-channel.

12. The device according to claim 11, wherein the device is an access point device, and the device further comprises:
a third setting unit, configured to set a pre-designated number corresponding to the first device as the maximum quantity of the channel elements participating the competition; or
a fourth setting unit, configured to set a quantity of all channel elements comprised in the target channel as the maximum quantity of the channel elements participating thereon.

13. The device according to claim 11, wherein:
the processor is further configured to confirm a success in a competition for a first target channel element once the channel competition device receives on a first target channel element the response frame sent by the second device, wherein the first target channel element is one or more channel elements comprised in the N channel elements; or
the processor is further configured to confirm a success in a competition for the N channel elements once the channel competition device receives on a second target channel element the response frame sent by the second device, wherein the second target channel element is any one channel element or any multiple channel elements comprised in the target channel.

14. A channel competition device, comprising a receiver and a transmitter, wherein:
the receiver is configured to receive, on a target sub-channel, a request frame sent by a first device wherein the target sub-channel is at least one sub-channel of one or more idle sub-channels in idle state comprised in a target channel; and
the transmitter is configured to generate a response frame in response to the request frame, and transmit the response frame to the first device, so that the first device confirms a success in a competition for the target sub-channel.

15. The device according to claim 14,
wherein the target channel comprises a plurality of channel elements, and the channel elements comprises at least one sub-carrier or at least one sub-channel; and
wherein the receiver is further configured to receive, on N channel elements comprised in one or more idle channel elements, the request frame sent by the first device wherein the idle channel element is channel element in idle state comprised in the target channel, N is less than or equal to M, and M is a maximum quantity, preset by the first device, of channel elements participating the competition.

16. The device according to claim 15, wherein
the transmitter is further configured to transmit, on a first target channel element, the response frame to the first device, so that the first device confirms a success in the competition for the first target channel element, wherein the first target channel element is one or more channel elements comprised in the N channel elements; or
the transmitter is further configured to transmit, on a second target channel element, the response frame to the first device, so that the first device confirms a success in a competition for the N channel elements, wherein the second target channel element is any one channel element or any multiple channel elements comprised in the target channel.
